(19) United States
(12) Patent Application Publication
(10) Pub. No.: US 2004/0008505 A1
(43) Pub. Date: Jan. 15, 2004

(54) Keyboard with illumination module and fabrication method thereof

(75) Inventor: Chih-Hsiang Chiang, Taoyuan (TW)

Correspondence Address: QUINTERO LAW OFFICE, 1617 BROADWAY, 3RD FLOOR, SANTA MONICA, CA, 90404, US

(73) Assignee: Darfon Electronics Corp.

(21) Appl. No.: 10/409,288

(22) Filed: Apr. 8, 2003

(30) Foreign Application Priority Data
Apr. 12, 2002 (TW) 91107508

(51) Int. Cl. F21V 7/04

(52) U.S. Cl. 362/31

(57) ABSTRACT

A keyboard with an illumination module and the fabrication method thereof. The illuminated keyboard includes a light-guiding plate disposed between a foundation plate and a plurality of keys. A plurality of optical fibers are arranged in parallel with one end of each embedded in the light-guiding plate at the aide surface. The other ends of the optical fibers are attached to a light source. A reflective layer is attached to the back surface of the light-guiding plate.

### BACKGROUND OF THE INVENTION

1. Field of the Invention

The present invention relates to an illumination module and the fabrication method thereof, and in particular to an easily fabricated illumination module for electronic devices.

2. Description of the Related Art

Many kinds of flat illumination modules have been developed. FIGS. 1A and 1B show a flat illumination module of a conventional electronic device. The illumination module 10 includes a light-guiding plate 11 is and a plurality of light sources 12. The light sources 12 are usually LEDs arranged beside the light-guiding plate 11. The light emitted by the LEDs is directly introduced into the light-guiding plate 11.

Generally, electronic devices are required to have smaller profiles and lighter weight, especially for portable electronic devices. In order to reduce weight, every element of electronic devices must become thinner or smaller, including the illumination module. However, conventional LED packages have a predetermined thickness as shown in FIG. 1B. When the light-guiding plate 11 is thinner than the LED 12, a large portion of light emitted from the LED 12 does not enter the light-guiding plate 11. The light coupling ratio decreases. Thus, more LEDs 12 are needed, which will increase the weight and consume more energy. Hence, there is a need for a new flat illumination module with better light coupling ratio.

### SUMMARY OF THE INVENTION

Accordingly, an object of the invention is to provide a better illumination module and the fabrication method thereof. It also provides a keyboard including the illumination module of the invention to simplify the fabrication process and reduce cost.

The present invention is to provide an illumination module and the fabrication method thereof. The method first comprises providing a light-guiding plate having a back surface and a side surface. Next, a plurality of optical fibers are arranged in parallel with one end of is each connected to the side surface of the light-guiding plate. A reflective layer is disposed on the back surface of the light-guiding plate. Finally, the other ends of the optical fibers are bundled and attached to a light source.

According to the preferred embodiment, the light source is a LED. The light-guiding plate is made by injection molding. The optical fibers are embedded in the light-guiding plate at the side surface or directly glued on the side surface. The reflective layer is made by coating or merely formed by a reflective membrane attached to the back surface of the light-guiding plate.

The present invention also provides an illuminated keyboard. The illuminated keyboard includes a keyboard body having a foundation sheet and a plurality of keys key caps movably connected to the foundation sheet. A light-guiding plate is disposed under the foundation sheet. A plurality of optical fibers are arranged in parallel with one end of each embedded in the light-guiding plate at the side surface and the other ends attached to the light source. A reflective layer is formed on the back surface of the light-guiding plate.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic top view of a conventional illumination module;

FIG. 1B is a schematic side view of the illumination module shown in FIG. 1A;

FIG. 2 is a flowchart of the fabrication method for the illumination module of the invention;

FIG. 3A is a schematic top view of an illumination module of the invention;

FIG. 3B is a schematic top view of another illumination module of the second embodiment;

FIG. 3C is a partial cross section of the illumination module of the invention;

FIG. 3D is another partial cross section of the illumination module of the invention;

FIG. 4A is a top view of an illuminated keyboard of the invention;

FIG. 4B is a exploded perspective view of a key of the keyboard with the illumination module of the invention; and

FIG. 4C is a cross section of a key of the illuminated keyboard of the invention,

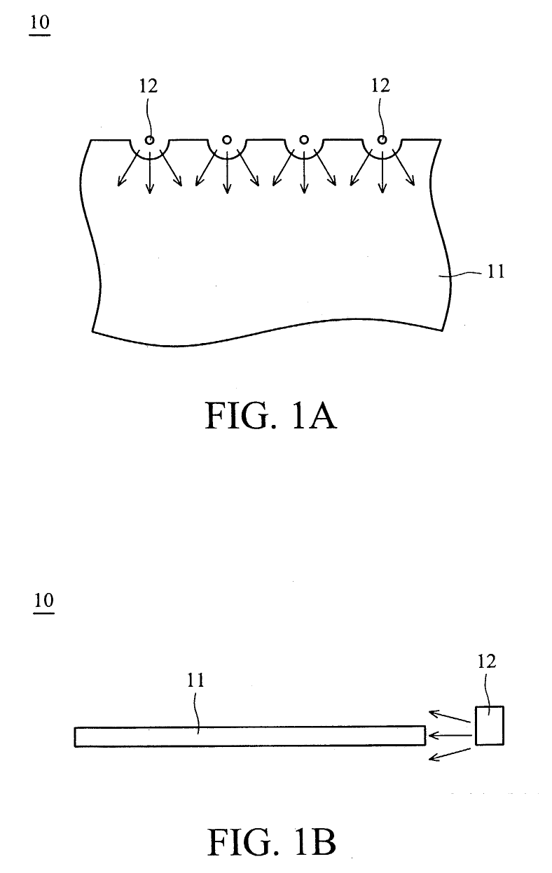

### DETAILED DESCRIPTION OF THE INVENTION

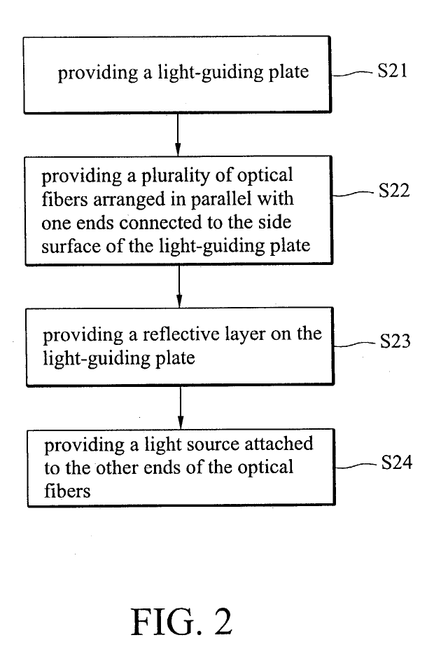

FIG. 2 is a flowchart of the fabrication method for the illumination module of the invention. The method first comprises providing a light-guiding plate having a back surface and a side surface (S21). Next, a plurality of optical fibers are arranged in parallel with one end of each connected to the side surface of the light-guiding plate (S22). A reflective layer is disposed on the back surface of the light-guiding plate (S23).

Finally, the other ends of the optical fibers are bundled and attached to a light source (S24).

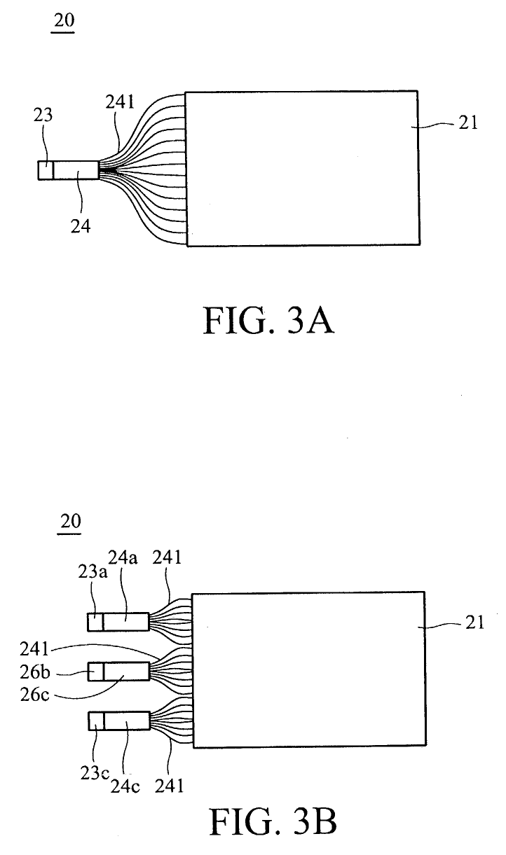

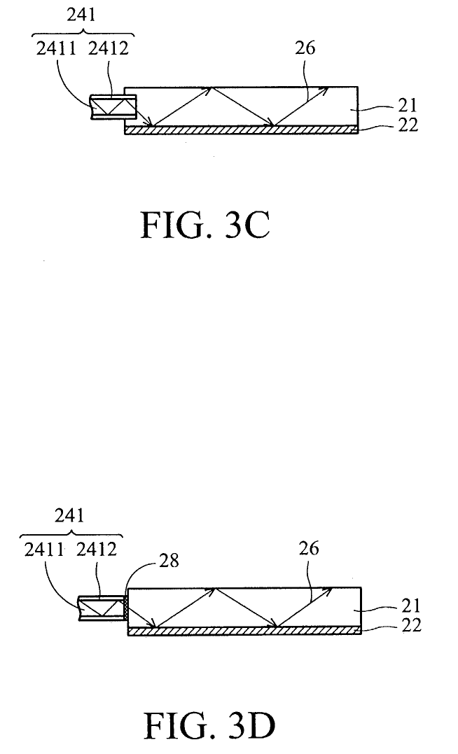

The illumination module fabricated by the method above is shown in FIGS. 3A-3D. In FIG. 3A, the illumination module 20 comprises a light-guiding plate 21, reflective layer 22 (in FIG. 3C), a plurality of optical fiber 241 and a light source 23. One end of each of the optical fibers are arranged in parallel and connected to the wide surface of the light-guiding plate 21. The other ends of the optical fibers 241 are bundled together, forming a bundle of fibers 24, and attached to a light source 23.

Another embodiment is shown in FIG. 3B. In FIG. 3B, the optical fibers are divided into three groups, forming three bundles of fibers 24a, 24b, and 24c. Moreover, three light sources 23a, 23b, 23c are attached to each of the fiber groups to introduce more light into the light-guiding plate 21.

FIG. 3C is a partial cross section of the illumination module. In FIGS. 3A and 3C, the light source 23 is a LED. The optical fiber 241 has a core 2411 and a cladding layer 2412. One end of each of the optical fibers 241 are bundled together, forming a bundle portion 24 attached to the surface of the LED 23. The other ends of the optical fibers 241 are embedded in the light-guiding plate 21 at the side surface. When is fabricating the illumination module 20 of this embodiment, one end of each of the optical fibers 241 are placed at the edge of a plane mold by which the light-guiding plate 21 is formed. After the light-guiding plate 21 is formed by injection molding, the ends of the optical fibers 241 are embedded in the light-guiding plate 21 at the side surface. Thus, the light 26 emitted from the LED 23 can be introduced into the light-guiding plate 21 through the optical fiber 241. Moreover, the light-guiding plate 21 is made of Acrylic, PC or ABS.

FIG. 3D shows another bonding method for connecting the light-guiding plate and the optical fibers. In FIG. 3D, the optical fibers 241 are directly glued on the side surface of the light-guiding plate 21. The glue 28 can be thermosetting glue or UV-cured glue. Thus, the light 26 emitted from the LED 23 can be introduced into the light-guiding plate 21 through the optical fiber 241.

According to the embodiment of the invention, the reflective layer 22 is formed by coating or printing on the back surface of the light-guiding plate 21. The reflective layer 22 can be a reflective membrane glued thereto. Thus, the light introduced into the light-guiding plate is reflected by the reflective layer.

The illumination module can be used in many kinds of electronic devices. The following description takes a keyboard with the illumination module of the invention as an example.

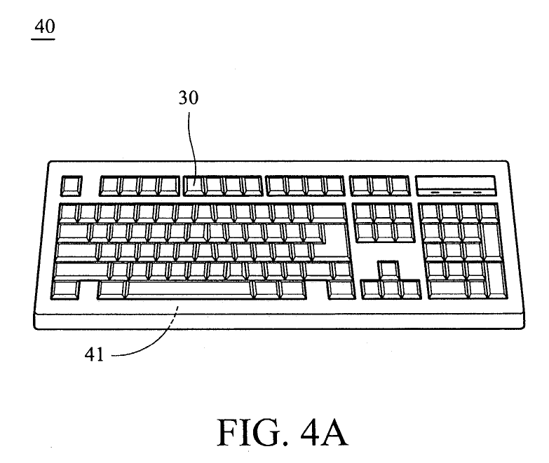

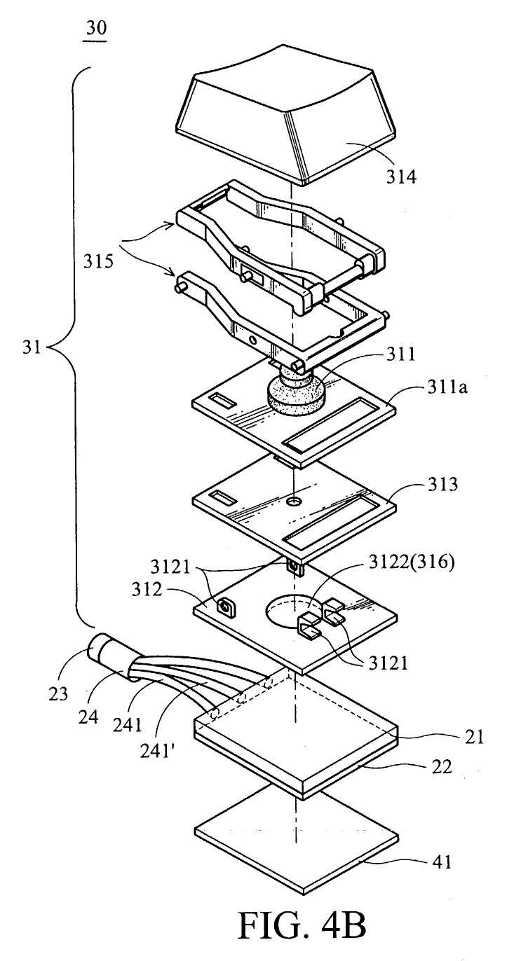

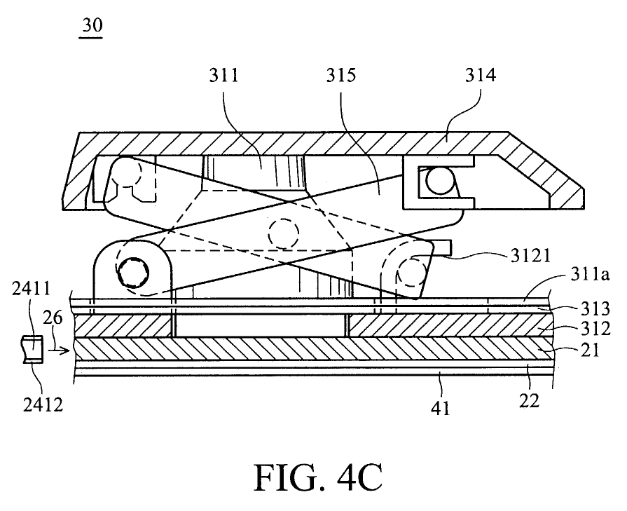

FIG. 4A shows an illuminated keyboard with the illumination module of the invention. In order to is simplify the drawing, FIGS. 4B and 4C only show a single key of the illuminated keyboard in FIG. 4A.

In FIG. 4A˜4C, the keyboard includes a foundation sheet 312 with a plurality of keys 30 and an illumination module 20 of the invention. The illumination module 20 is disposed between the foundation sheet 312 and the back housing 41 of the keyboard 40. The key structure 31 of the keyboard 40 includes a key cap 314, cap support 315, elastic dome 311, circuit membrane assembly 313 and a foundation sheet 312. One end of the cap support 315 is connected to the fixing points 3121 on the foundation sheet 312; the other is connected to the bottom of the key cap 314, such that the key cap 314 is movable with respect to the foundation sheet. The elastic dome 311 is disposed between the circuit membrane assembly 313 and the key cap. The foundation sheet also has a through hole 3122 under the elastic dome. The through hole is selectively filled with light-guiding material 316. The circuit membrane assembly 313 is made of light-guiding plastic, such as PE. The elastic domes of the key structure 31 can be glued on an elastic membrane 311a to simplify the fabricating process. Otherwise, the elastic domes and the elastic membrane can be formed integrally.

The illumination module 20 of the invention is disposed under the foundation sheet 312. One end of each of the optical fibers 241 are arranged in parallel and connected to the side surface of the light-guiding plate 21. The other ends of the optical fibers 241 are bundled together, forming a bundle of fibers 24, and attached to a light source(s) 23. The light emitted from the light source 23 is introduced into the light-guiding plate 21. According to the illumination module 20 of the invention, light can be reflected or refracted to the key structure 31, providing required light to the illuminated keyboard 40 of the invention.

Moreover, the light-guiding plate 21 can be as thin as the optical fibers 241, such as 0.125-0.8 mm for example. When fabricating the illumination module 20, one end of each of the optical fibers 241 in connected to the light-guiding plate 21. The other ends of the optical fibers 241 are bundled together, forming a bundle portion 24 attached to the surface of the LED 23. Thus, the light emitted from the LED 23 can be introduced into the light-guiding plate 21 through the optical fiber 241.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for fabricating an illumination module, comprising:
providing a light-guiding plate having a back surface and a side surface;
providing a plurality of optical fibers arranged in parallel with one end of each connected to the side surface of the light-guiding plate;
providing a reflective layer, disposed on the back surface of the light-guiding plate; and
providing a light source, attached to the other ends of the optical fibers.

2. The method as claimed in claim 1, wherein the light source is a LED.

3. The method as claimed in claim 1, wherein the light-guiding plate is made by injection molding.

4. The method as claimed in claim 1, wherein the optical fibers are embedded in the light-guiding plate.

5. The method as claimed in claim 1, wherein the reflective layer is formed by coating.

6. The thing as claimed in claim 1, wherein the reflective layer is a reflective membrane attached to back surface of the light-guiding plate.

7. An illumination module, comprising:
a light source;
a light-guiding plate, having a back surface and a side surface;
a plurality of optical fibers, arranged in parallel with one end of each connected to the side surface of the light-guiding plate and the other ends attached to the light source;
a reflective layer, disposed on the back surface of the light-guiding plate.

8. The illumination module as claimed in claim 7, wherein the light source is a LED.

9. The illumination module as claimed in claim 7, wherein the light-guiding plate is made by injection molding.

10. The illumination module as claimed in claim 7, wherein the optical fibers are embedded in the light-guiding plate.

11. The illumination module as claimed in claim 7, wherein the reflective layer is formed by coating.

12. The illumination module as claimed in claim 7, wherein the reflective layer is a reflective membrane attached to back surface of the light-guiding plate.

13. An illuminated keyboard, comprising:
a keyboard body, having a foundation sheet and a plurality of keys having key caps movably connected to the foundation sheet;
a light source;
a light-guiding plate, having a back surface and a side surface and disposed under the foundation sheet;
a plurality of optical fibers, arranged in parallel with one end of each connected to the side surface of the light-guiding plate and the other ends attached to the light source;
a reflective layer, disposed on the back surface of the light-guiding plate.

14. The illuminated keyboard as claimed in claim 13, wherein the light source is a LED.

15. The illuminated keyboard as claimed in claim 13, wherein the light-guiding plate is made by injection molding.

16. The illuminated keyboard as claimed in claim 13, wherein the optical fibers are embedded in the light-guiding plate.

17 The illuminated keyboard as claimed in claim 13, wherein the reflective layer is formed by coating.

18. The illuminated keyboard as claimed in claim 13, wherein the reflective layer is a reflective membrane attached to the surface of the light-guiding plate.
